(19) United States
(12) Patent Application Publication
(10) Pub. No.: US 2018/0317389 A1
(43) Pub. Date: Nov. 8, 2018

(54) Device for Harvesting Stalk-Like Stem Crops

(71) Applicant: Carl Geringhoff GmbH & Co. KG, Ahlen (DE)

(72) Inventors: André HEMMESMANN, Sassenberg (DE); Thomas GERSMANN, Warendorf (DE); Martin BEUMKER, Wadersloh (DE); David SCHARMANN, Beckum (DE)

(21) Appl. No.: 15/758,360

(22) PCT Filed: Sep. 21, 2016
(86) PCT No.: PCT/EP2016/001577

§ 371 Date: Jul. 28, 2018

(30) Foreign Application Priority Data
Sep. 28, 2015 (DE) 10 2015 116 372.1

(51) Int. Cl. A01D 45/02; A01D 61/00

(52) U.S. Cl. CPC A01D 45/025; A01D 61/006

(57) ABSTRACT

The present invention relates to a device (2) for harvesting stalk-like stem crops, having a number of picking units (10) which are arranged alongside one another on the frame of the device (2) and each have at least one picking rotor (12), picking plates laterally delimiting a picking gap, and conveying units which are assigned thereto and are configured as continuous conveyors (14) that are driven in circulation, a series gearbox (26) that drives the members of each picking unit (4), longitudinal beams (22), in arranged between the picking gaps, for supporting members of the picking units (10), a transverse beam (8) to which the picking units (10) are fastened, and a transverse conveying device (24) arranged downstream of the conveying units. In order to design the known devices such that they can be operated with a shallower setting angle of the picking units without pushing residual harvested material into heaps with their undersides, it is proposed that the picking units (10) be connected to the transverse beam (8) at their rear sides via the series gearbox (26) and/or via a longitudinal beam (22) and that the transverse beam (8) be arranged in a horizontal plane in which the series gearbox (26) of the picking units (10) is also arranged

The present invention relates to a device for harvesting stalk-like stem crops, said device having a number of picking units, which are arranged side by side on the frame of the device and each have at least one picking rotor, picking plates that laterally delimit a picking gap, and conveying units that are assigned to said plates and are configured as continuous conveyors that are driven in circulation, said device also having a series gearbox for each picking unit that drives the elements thereof, longitudinal beams arranged between the picking gaps for supporting elements of the picking units, a transverse beam to which the picking units are attached, and a transverse conveying device located downstream of the conveying units.

For the most part, the devices of interest here for harvesting stalk-like stem crops are installed on combine harvesters as corn picker heads for harvesting corn grain. In the corn picker heads, the ears of corn are separated from the stalks, the stalks and leaves are discarded onto the ground, and the picked ears of corn are delivered to the combine harvester for threshing. The picking operation is carried out by the picking units, which push the plant stalk down with at least one picking rotor once the plant stalk has entered the picking gap, which is delimited by at least one laterally disposed picking plate. When an ear of corn attached to the corn stalk reaches the picking gap, it becomes caught on the picking plate(s) and tears away from the stalk because it is wider than the picking gap. The stalk is carried further downward and is shredded along with the leaves as residual plant matter, by blades that are located beneath the picking plates. The chopped up residual plant parts form a straw mat, which is driven over by the harvester. The carrier elements, which circulate continuously with the circulating conveyors, for example chain conveyors or belt conveyors, catch the separated ears of corn and feed them to the transverse auger, which collects the separated ears of corn at the center of the device and delivers them rearward to the combine harvester. In addition to the picking plates, the picking rotors and the shredding device, a picking unit typically employs two circulating conveyors, which have conveyor chains or belts, for example, and are situated in a plane above the picking plates and on both sides of the picking gap. The picking rotors and the circulating conveyors, which are assigned to a picking gap that receives a row of the crop, are driven via a series gearbox assigned to each of the elements of said picking gap.

In addition to removing the ears of corn from the area of the picking gap, the circulating conveyors also serve to pick up and lift any cornstalks that are lying on the field in the area of the front deflecting wheel such that these cornstalks can enter the picking gap. For this purpose, it is important for the front end of the circulating conveyor to extend as close to the ground as possible. The position of the lowest point on the circulating conveyor is determined by the spatial disposition of the front deflecting wheel, since the deflecting wheel is circular in shape, and therefore, as the circulating conveyor travels around the deflecting wheel it reaches its lowest point at only one location.

Especially under difficult harvesting conditions, it is desirable for the front end of the corn picker to be guided as low and close to the ground as possible, so that as much of the crop material as possible can be picked up off the ground. And once the crop material has been picked up, it is also important to prevent the grains from falling back out of the corn picker and being lost. To avoid losses, it is advantageous for the setting angle of the device to be as shallow as possible. However, when the device is operated at a shallow setting angle and is guided close to the ground, the problem arises that the underside of the device tends to carry plant material from the straw mat along and push it into a pile, which eventually reaches into the picking units where it obstructs the flow of harvested material. In addition, the components on the underside of the device experience undue wear and tear due to contact and friction with the moist and soil-laden parts of the plant, impacts with stones, and other contact with the ground.

Document No. DE 203 03819 U1 discloses a device of the type in question. A similar assembly is described in document No. DE 20 2011 110622 U1. The picking units described in said documents, each of has an exposed conveyor unit, are each equipped with a series gearbox, which is flange-mounted on the rear end of the picking unit. The underside of the series gearbox is placed on a transverse beam located there beneath, and is secured in its mounted position on said transverse beam via clamping bridges. The setting angle of the picking units is relatively steep. Thus, apart from the chopping device, the transverse beam at the rear area of the device and behind the picking units forms nearly the lowest point on the device. The transverse beam is situated below the picking units and protrudes outward from the surface on the underside of the device as a contour that disrupts the material flow of the chopped-up plant parts. If the picking units were to be lowered by lowering the transverse beam further into a shallower setting angle, the transverse beam would push along the chopped-up residual plant material that has been discarded onto the ground.

When front or rear is discussed in this description, this specification refers to the orientation of the device toward the standing portion of the crop material being harvested. Thus, the front is the area of the device that is being moved into the standing crop, and the rear is the direction in which the crop material that has been collected by the device is delivered to the combine harvester.

It is the object of the present invention to configure the known devices such that they can be operated with the picking units at a shallower setting angle, without the undersides of the picking units pushing residual crop material into piles.

The object is achieved for a device of the type in question in that each of the picking units is connected at its rear to the transverse beam via the series gearbox and/or via a longitudinal beam, and the transverse beam is located in the same horizontal plane in which the series gearboxes of the picking units are located.

Positioning the transverse beam and the series gearboxes at the same height in the horizontal direction results in a shallower underbody contour, enabling the picking units to be placed at a shallower setting angle without thereby increasing the risk that the underbody of the device might push chopped-up crop material from the straw mat into undesirable piles. Positioning said components at the same height does not mean that the one or more tubes of the transverse beam and the series gearbox must each have the same overall height and must be arranged with their undersides or upper sides at the same height. Any offset that may result from different dimensions of the components is not critical. The advantages of the invention are realized even when the components are arranged such that at least certain regions thereof are situated at the same horizontal height. Simply arranging the components one behind the other rather than one on top of the other allows the transverse beam and/or the series gearbox to be positioned lower, both of which result in a shallower underbody contour and permit a shallower setting angle of the picking units. The shallower setting angle of the picking units directly reduces losses from grain and ears of corn dropping out of the device. The circulating conveyors can be designed as less aggressive, which likewise reduces losses and broken grain percentages. Guiding the device close to the ground under difficult harvesting conditions is facilitated because the device does a better job of reaching underneath plants lying on the ground, and can therefore more securely pick up, lift and process these.

Another advantage is that the friction-induced wear of the components on the underside of the device is decreased. The shallower and smoother underbody contour reduces the cavities in which residual plant material can accumulate and impede the flow of crop material. As a result, the device slides better over the straw mat composed of chopped-up residual plant material. The transverse beam is now in a more sheltered position where it is less likely to strike obstacles and become damaged.

If the picking units are connected to the transverse beam via one or more longitudinal beams rather than via the series gearbox, there is the additional advantage that forces acting on the longitudinal beams are introduced to the transverse beam via the longitudinal beams rather than from the gearbox housing, and are introduced via said transverse beam to the frame of the device. When this connection is made via the series gearboxes, the gearbox housings must be designed to withstand the loads acting on them; now, however, the gearbox housings can be made much lighter in weight and less costly. The savings realized by this are multiplied based on the number of picking rows. As simple sheet metal parts, the longitudinal beams can be adapted to higher load peaks much more easily and at much lower cost. Any overload-induced damage to the longitudinal beams can be repaired much more quickly and cost-effectively than if the gearboxes become damaged. However, the series gearboxes may also be connected to the transverse beam, for example, to reinforce the overall structure, to improve the support of the series gearboxes, or to relieve the longitudinal beams of drive influences.

According to one embodiment of the invention, the transverse beam is embodied as a double tube composed of two tubes arranged spaced from one another vertically. The double-tube design enables a short structure in the longitudinal direction of the machine, in which the distance between the two tubes creates a larger lever for absorbing the acting forces, as compared with a single-tube transverse beam, and at the same time, the position of the two tubes provides an unambiguous installation position for the picking units and the longitudinal beam via the fittings used. The double tubes can each be round in cross-section, although other cross-sectional shapes for each tube are also possible, for example polygonal, oval or other cross-sectional profile shapes, such as a bone shape. Protrusions, ribs, webs or the like that reinforce the tube and spatially define the longitudinal beams may also be formed on the profile. Hollow profiles or solid profiles may be used. The double tubes form a rail over their length, along which the longitudinal beams and/or the series gearboxes are strung together side by side, suspended from the fittings, to assemble the device. The components can also be removed from the rail easily for repair, by sliding them in a transverse direction up to a lateral end of the transverse beam. For more difficult repairs of individual picking units or individual longitudinal beams, a single non-functioning picking unit or a single io longitudinal beam can be replaced with a replacement picking unit or single longitudinal beam with little effort, allowing the device to be rapidly returned to use in the harvesting operation.

According to one embodiment of the invention, the transverse beam is designed as a sheet metal structure, which is connected to the sheet metal trough of the transverse conveying device. A sheet metal structure means that the transverse beam is composed of correspondingly shaped metal sheets. The sheet metal structure obtains its strength from a corresponding formation of beads, folds and edges in the initial sheet metal blank. Cross-sectional shapes can be incorporated into the area of the sheet metal structure where the longitudinal beams are attached, and can be used for the positive connection of the longitudinal beams to the sheet metal structure. Of course, it is alternatively or additionally possible for this connection to be made using auxiliary connectors such as screws, rivets and the like.

According to one embodiment of the invention, each of the series gearboxes is attached to one or to two adjacent longitudinal beams, and these longitudinal beams are attached to the transverse beam. In this design, the longitudinal beams and a corresponding series gearbox together make up a series module, which is connected to the transverse beam solely via the longitudinal beams. The remaining components of the picking units can be easily attached to the series gearbox and the longitudinal beams. Hoods, crop dividers and other components can also be easily added on to the series module. The series modules can be easily mounted and replaced for repair purposes. Since the forces acting on the series module are transmitted to the transverse beam via the longitudinal beams, the gearbox housing is relieved of these loads and can therefore be designed as lighter weight.

According to one embodiment of the invention, each of the longitudinal beams is suspended from the transverse beam by at least one hook-like bracket. The hook-like bracket enables a connection in which the securing forces are transmitted from the longitudinal beam to the transverse beam directly via the bracket. The hook-like bracket is shaped such that when the longitudinal beam is suspended from the transverse beam by the hook-type bracket, a self-locking connection is established between the hook-like bracket and the transverse beam, based solely on the shape of said bracket and the weight of the suspended components acting thereon. This simplifies assembly and reduces the number of parts required for connecting the components. The suspension via the hook-like bracket is made possible by the horizontal arrangement of the transverse beam to the rear of the series gearbox, rather than a vertical positioning in which the series gearbox is mounted on top of the transverse beam.

According to one embodiment of the invention, at the rear end of the longitudinal beam, a hook-like bracket is formed in the upper region of the longitudinal beam and an additional hook-like bracket and/or a clamping element is formed in the lower region of the longitudinal beam, and the two hook-like brackets or the bracket of the longitudinal beam and the clamping element attached to the longitudinal beam encompass the transverse beam in a positive connection. The two hook-like brackets or the bracket with the attached clamping element together produce a secure spatial immobilization of the longitudinal beam, with effective support and transmission of forces from the longitudinal beam to the transverse beam, and back. The clamping element can encompass the transverse beam in certain areas, thereby producing a stable seating. With two longitudinal beams per picking unit, this results in a four-point suspension of each picking unit on the transverse beam via four hook-like brackets, which picking unit is mounted quickly and easily but is highly stable. In the transverse direction, the longitudinal beams can be positioned resting against longitudinal beams of an adjacent picking unit, so that additional immobilization in the transverse direction can be dispensed with. It is possible for only the outer side of each of the outer picking units to be secured, thereby securing all the picking units of the device in the transverse direction.

According to one embodiment of the invention, at least one of the hook-like brackets is an integral part of the longitudinal beam, formed from a piece of sheet metal. If the longitudinal beam is embodied as a sheet metal part, the hook-like bracket may be a component of the integral sheet metal part, which has corresponding peripheral contours when the sheet metal blank is punched or treated with a laser. The hook-like brackets can be brought into the desired shape by reforming the sheet metal part. With a suitable design of the sheet metal parts, the brackets can be produced by simply bending the sheet metal parts, without the use of costly special tools. However, the brackets may also be attached to the longitudinal beams by conventional means, such as welding, screwing, riveting or joining.

According to one embodiment of the invention, in the region where the series gearboxes are located, the longitudinal beams have openings in their side walls, through which a shaft can be fed. Driving forces can be transmitted from one series gearbox to an adjacent series gearbox through the openings in the side walls of the longitudinal beams, simply by the insertion of a connecting shaft between the series gearboxes and through the openings. If the openings are embodied as holes that are surrounded by side wall bridges of sufficient width, the static load capacity of the longitudinal beam will not be unduly limited by the opening, even if the opening is located in an area of horizontal overlap between the series gearbox and the transverse beam. The openings can also be introduced into the material of the side walls by simple punching or laser treatment.

According to one embodiment of the invention, the transverse beam, as part of the frame, connects longitudinal braces to one another transversely at their forward-facing ends, said longitudinal braces extending forward from a rear transverse tube, underneath the transverse conveying device and through to the front. The transverse beam is thus part of a framework of the device, which absorbs the forces introduced into the transverse beam, distributes said forces within the framework structure, and transmits them to the carrier machine. Overall, the framework is relatively lightweight, but is still stable enough to hold the picking units and to absorb average impact forces resulting from collisions of the longitudinal beams with the ground. When double tubes spaced apart from one another are used as the transverse beam, this results in a further improvement of the rigidity of the framework structure over that of a single tube, enabling the weight of the framework structure to be reduced.

It is expressly understood that the above-described embodiments of the invention may each be combined individually, or in any combination with one another, with the subject matter of the main claim.

Further modifications and embodiments of the invention can be found in the following subject matter description and in the set of drawings.

The invention will be described below in reference to an exemplary embodiment. The figures show:

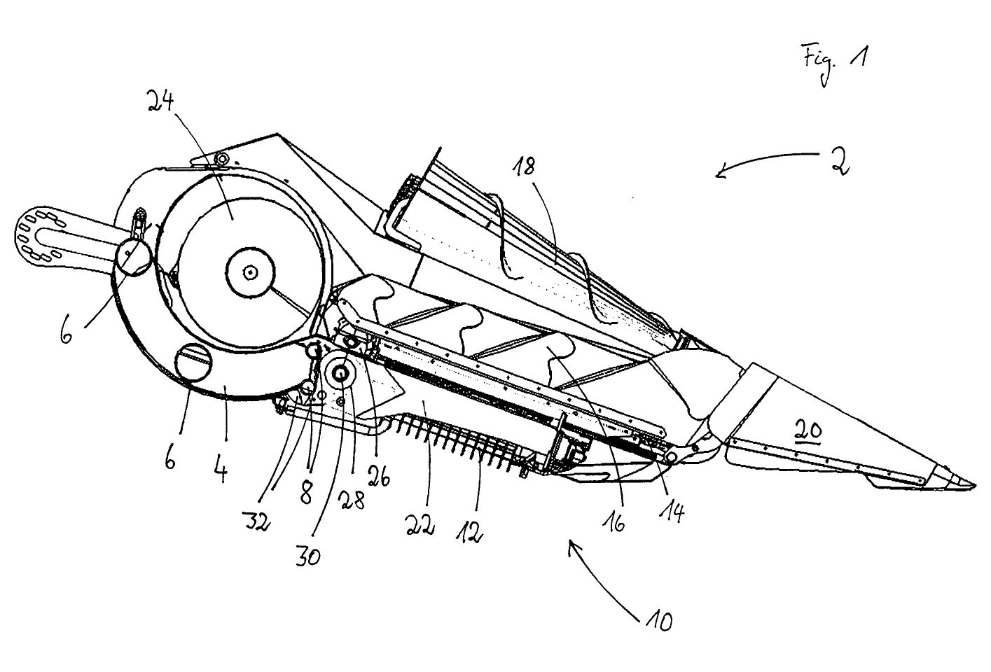

FIG. 1: a side view of a device,

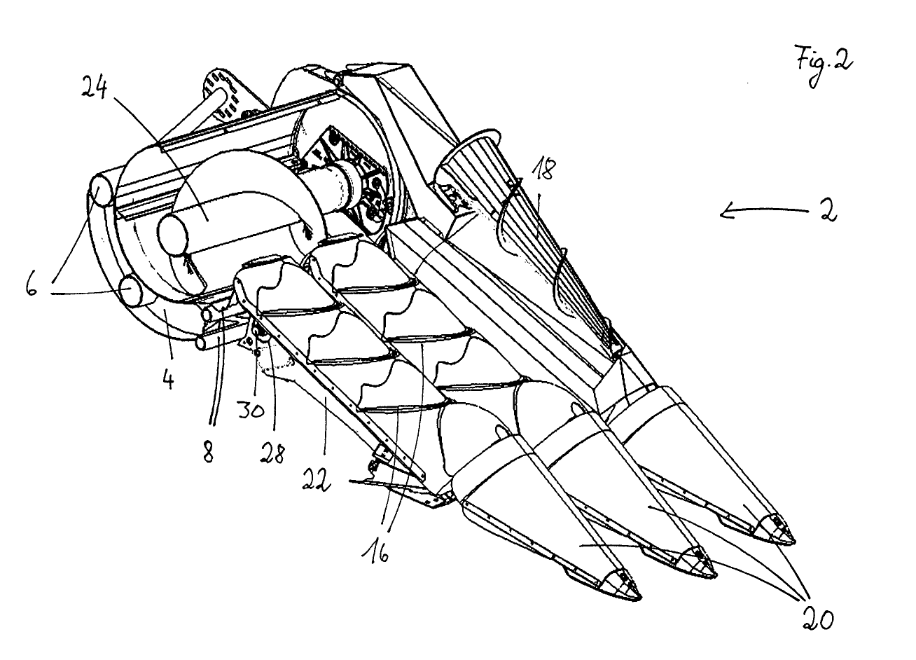

FIG. 2: an oblique frontal view of a part of the device shown in FIG. 1,

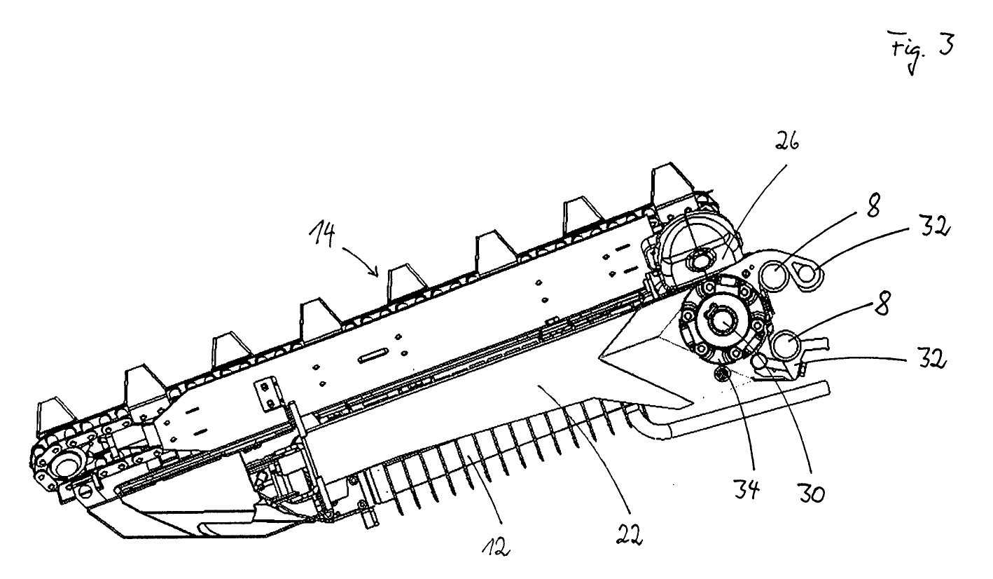

FIG. 3: a side view of a series module,

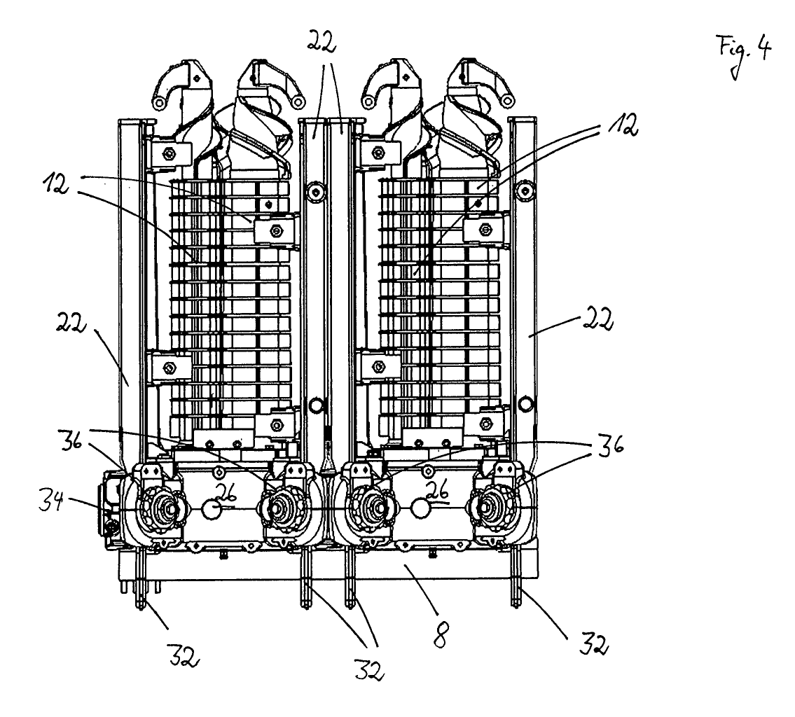

FIG. 4: a view from above of two series modules suspended from the transverse beam,

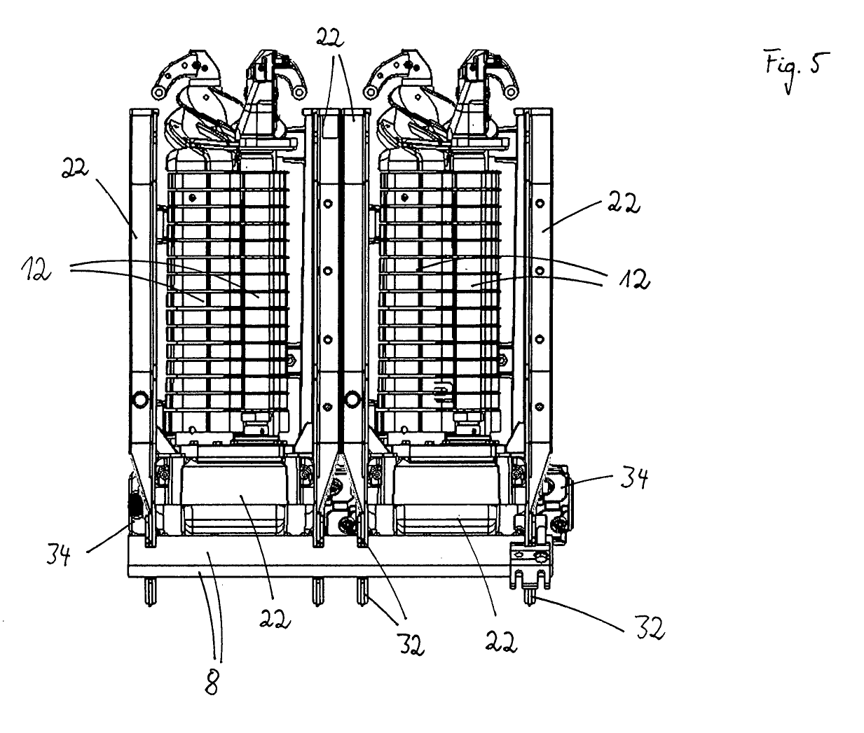

FIG. 5: a view from below of two series modules suspended from the transverse beam, and

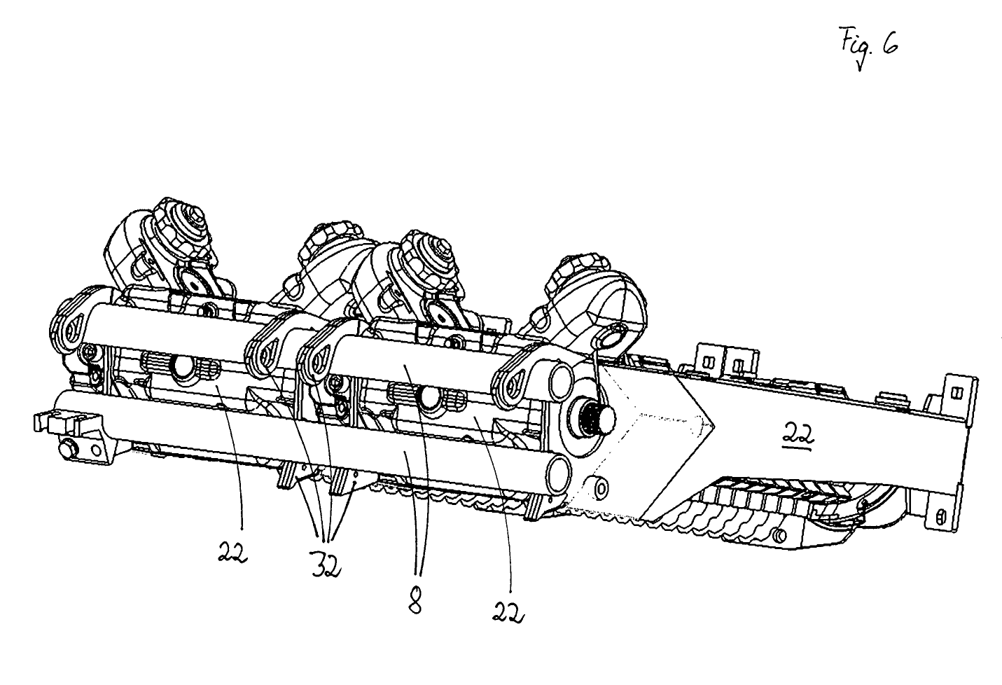

FIG. 6: an oblique rear view of two series modules suspended from the transverse beam.

FIG. 1 shows a side view of a device 2. The device 2 described as an exemplary embodiment is a corn picker, the frame of which is composed of longitudinal braces 4 and transverse tubes 6 assembled to form a framework. The longitudinal braces 4 extend forward from the two rear transverse tubes 6, and are connected to one another in the transverse direction at their forward facing, unattached ends via the transverse beam 8. In the exemplary embodiment, transverse beam 8 is a double-tube structure, in which two tubes that are round in cross-section are connected, spaced a vertical distance from one another, to the longitudinal braces 4.

A number of picking units 10 are attached to transverse beam 8. Each picking unit is equipped with a picking rotor 12, located beneath an associated picking plate. Above the picking plate are circulating conveyors 14, which in FIG. 1 are beneath a covering hood 16 and are not visible. On the side of device 2 is a rotatably driven crop divider 18. Upstream of the picking units 10 are picker fingers 20, which serve to guide the incoming plant stalks toward the respective picking gaps.

The picking units 10 are attached to longitudinal beams 22. The picking units 10 convey the harvested ears of corn rearward to the transverse conveying device 24, which uses its auger to collect the ears of corn centrally and deliver them rearward to a combine harvester, which acts as a carrier vehicle.

Each of picking units 10 is driven via a series gearbox 26, which is located between io the longitudinal beams 22. Longitudinal beams 22 are equipped on their side walls with openings 28, through which a shaft 30 is fed, which transmits mechanical drive power to the series gearboxes 26. Longitudinal beams 22 are connected to transverse beam 8 via brackets 32.

FIG. 2 shows an oblique, frontal view of a part of device 2 shown in FIG. 1. As is clear from this three-dimensional perspective, the series modules can be easily pushed onto transverse beam 8 from the side. Picking units 10 are not more clearly visible in this view, because they are hidden by covering hoods 16.

FIG. 3 shows a side view of a series module. The series module is composed of longitudinal beams 22, between which a series gearbox 26 is located. On the series gearbox 26 and on the longitudinal beam 22, a circulating conveyor 14 is mounted.

A picking rotor 12 is partially concealed by longitudinal beam 22. A shaft coupling 34 for establishing a force fit between two adjacent series gearboxes 26 is placed on shaft 30. As is clear from the side view of FIG. 3, longitudinal beam 22 has a hook-like bracket 32 at its rear end in the upper region of longitudinal beam 22, and has an additional hook-like bracket 32 in the lower region of longitudinal beam 22. Each of the two brackets 32 partially encompasses one of the two tubes that form transverse beam 8, one from above and one from below. The form-fitting design of the brackets 32 holds longitudinal beam 22 securely and free of play on transverse beam 8. Not shown in FIG. 3 is the attachment of transverse beam 8 to the frame of device 2.

FIG. 4 shows a view from above of two series modules suspended from transverse beam 8. This view from above shows two picking rotors 12 per series module, the unattached ends of which point forward, and which are mounted toward the rear in respective series gearboxes 26. The two series gearboxes 26 are located between adjacent longitudinal beams 22. In the series module shown in FIG. 4, the circulating conveyors 14 have not yet been installed. Only the sprockets 36 are visible, which are attached to the series gearboxes 26 for the purpose of driving the circulating conveyors 14. Sprockets 36 are arranged obliquely at an angle from horizontal and protrude laterally slightly beyond the housing of the series gearbox. In the space between the oblique branches for sprockets 36, shaft couplings 34 can be accommodated at the level of shaft 30.

This is also clear from FIG. 5, which shows a view from below of two series modules suspended from the transverse beam.

FIG. 6 shows an oblique rear view of two series modules suspended from the transverse beam. As is clear from the oblique rear view, the two tubes of transverse beam 8 are arranged in a horizontal plane to the series gearboxes 22 of picking units 10. The branches on which sprockets 36 for driving the circulating conveyors 14 on shafts are mounted protrude beyond the transverse beam 8, the housing of series gearbox 26, the shaft couplings 34 located therebetween, and the brackets 32 with which longitudinal beams 22 are attached to transverse beam 8.

The exemplary embodiment described above is intended merely to illustrate the invention. The invention is not limited to the exemplary embodiment shown. A person skilled in the art will have no difficulty modifying the exemplary embodiment in a way that seems suitable for him to adapt it to a specific application.

What is claimed is:

1. A device (2) for harvesting stalk-like stem crops, the device comprising a number of picking units (10), which are arranged side by side on the frame of the device (2) and each have at least one picking rotor (12), picking plates that laterally delimit a picking gap, and conveying units that are assigned to said plates and are configured as continuous conveyors (14) that are driven in circulation, said device also having a series gearbox (26) for each picking unit (4) for driving the elements thereof, longitudinal beams (22) arranged between the picking gaps for supporting elements of the picking units (10), a transverse beam (8) to which the picking units (10) are attached, and a transverse conveying device (24) located downstream of the conveying units, characterized in that the picking units (10) are connected to the transverse beam (8) at their rear sides via the series gearbox (26) and/or via a longitudinal beam (22) and the transverse beam (8) is located in the same horizontal plane in which the series gearboxes (26) of the picking units (10) are located.

2. The device (2) according to claim 1, characterized in that the transverse beam (8) is embodied as a double tube composed of two tubes arranged spaced from one another vertically.

3. The device (2) according to claim 1, characterized in that the transverse beam (8) is designed as a sheet metal structure, which is connected to the sheet metal trough of the transverse conveying device (24).

4. The device (2) according to claim 1, characterized in that each series gearbox (26) is attached to one or to two adjacent longitudinal beams (22), and these longitudinal beams (22) are attached to the transverse beam (8).

5. The device (2) according to claim 1, characterized in that each of the longitudinal beams (22) is suspended on the transverse beam (8) via at least one hook-like bracket (32).

6. The device (2) according to claim 1, characterized in that at the rear end of the longitudinal beam (22), one hook-like bracket (32) is formed in the upper region of the longitudinal beam (22) and an additional hook-like bracket (32) and/or a clamping element is formed in the lower region of the longitudinal beam (22), and the two hook-like brackets (32) and/or the bracket (32) of the longitudinal beam (22) and the clamping element connected to the longitudinal beam (22) encompass the transverse beam (8) in a positive connection.

7. The device (2) according to claim 5, characterized in that at least one of the hook-like brackets (32) is an integral part of the longitudinal beam (22), which is formed from a piece of sheet metal.

8. The device (2) according to claim 1, characterized in that the longitudinal beams (22) have openings (28) in their side walls, in the region of the series gearboxes (26), through which a shaft can be fed.

9. The device (2) according to claim 1, characterized in that the transverse beam (8), as part of the frame, connects longitudinal braces (4) to one another transversely at their forward-facing ends, said longitudinal braces extending forward from a rear transverse tube (6), underneath the transverse conveying device (24) and through to the front.
